(19) United States
(12) Patent Application Publication
(10) Pub. No.: US 2017/0358250 A1
(43) Pub. Date: Dec. 14, 2017

(54) Backlit Display Systems With Localized Color-Changing Capability

(71) Applicant: Revolution Display, LLC, Glendale, CA (US)

(72) Inventor: Jeremy Hochman, Walnut, CA (US)

(21) Appl. No.: 15/621,697

(22) Filed: Jun. 13, 2017

Related U.S. Application Data
(60) Provisional application No. 62/349,378, filed on Jun. 13, 2016.

(51) Int. Cl. G09F 13/04; G02F 1/1362; G09G 3/34; G09G 3/36

(52) U.S. Cl. CPC G09F 13/04; G09G 3/3666; G02F 1/136277; G09G 3/3413; G09G 3/3426; G09G 2320/0233; G09G 2320/0646

(57) ABSTRACT

Aspects of the present disclosure include backlit graphical display systems that include an optically transmissive layer having one or more static images printed thereon for display, and a display located behind the optically transmissive layer. The display can be configured to colorize specific regions of the static images resulting in a backlit display having a very high resolution static shape with dynamic color and light intensity capability.

### RELATED APPLICATION DATA

This application claims the benefit of priority of U.S. Provisional Patent Application Ser. No. 62/349,378, filed Jun. 13, 2016, and titled Backlit Display Systems With Localized Color-Changing Capability, which is incorporated by reference herein in its entirety.

### FIELD OF THE INVENTION

The present invention generally relates to the field of backlit display systems. In particular, the present invention is directed to backlit display systems with localized color-changing capability.

### BACKGROUND

Backlit graphical displays include a translucent layer that contains a graphic for display and a light-source behind the translucent layer for illuminating the translucent layer. The light-source is commonly called a “light box.” Backlit graphical displays are used in a variety of applications, often for providing high-resolution, colorful, and bright signage in commercial spaces, such as commercial buildings, retail spaces, and outdoor spaces. The graphics on the translucent layer can be printed at a very high resolution, for example, as high as current printing technology allows, such as 2400 dpi, resulting in a high-resolution graphic. The graphical design on the translucent layer is static.

### SUMMARY OF THE DISCLOSURE

In one implementation, the present disclosure is directed to a backlit graphical display. The display includes a display having a display surface, the display including a plurality of pixels for displaying images based on video data received by the display; and an optically transmissive layer having a static image printed thereon, the optically transmissive layer positioned in front of the display surface, wherein the display colorizes the static image according to the video data.

In another implementation, the present disclosure is directed to a method of providing a backlit display. The method includes providing a display having a display surface; positioning an optically transmissive layer in front of the display surface, the optically transmissive layer having an image printed thereon; and colorizing the image with the display according to video data received by the display.

In yet another implementation, the present disclosure is directed to a method. The methods includes providing an optically transmissive layer having a translucent static image printed thereon; and creating video data according to the static image for use in colorizing the static image with an electronic display.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates an exploded view of a backlit display including a display and an optically transmissive layer;

FIGS. 2A-D show the display and an optically transmissive layer side by side with the display emitting differently-colored shapes for colorizing the image on the optically transmissive layer;

FIG. 3 is a flowchart of a method of displaying; and

FIG. 4 is a diagram of a computing device that can be used in connection with the methods and systems disclosed herein.

### DETAILED DESCRIPTION

Aspects of the present disclosure include backlit graphical display systems that include an optically transmissive layer having one or more static images printed thereon for display, and a display located behind the optically transmissive layer configured to colorize specific regions of the image printed on the optically transmissive layer. In one example, the display is a pixelated high resolution color display. And in some examples, the display is capable of forming a color image for display independently of the translucent layer. For example, the display may be a video display capable of displaying high resolution static images or video. The optically transmissive layer can be directly or indirectly coupled to a front surface of the display. By securing an optically transmissive layer with a static image to the front surface of a display, the system is capable of providing a backlit display having a very high resolution static shape with dynamic and uniform color and light intensity capability.

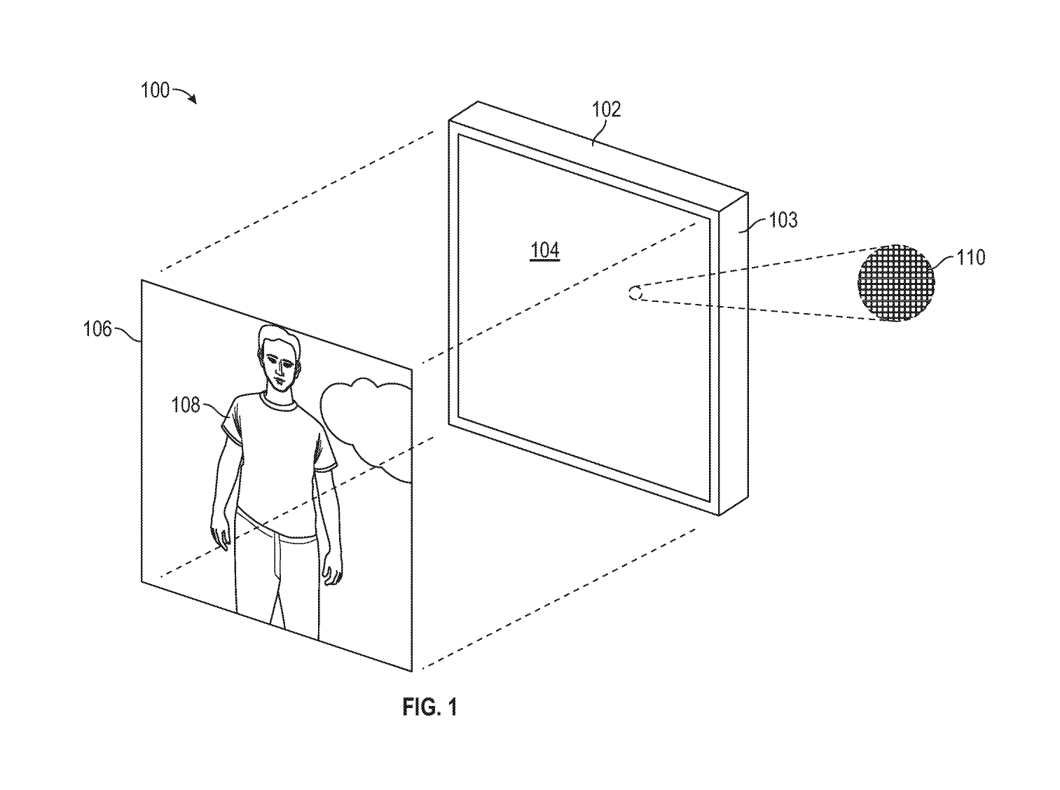

FIG. 1 illustrates an exploded view of one example backlit display 100 made in accordance with the present disclosure. Backlit display 100 includes a display 102 having a housing 103 and a display surface 104 configured to emit light to form high resolution images according to video data received by the display. Backlit display 100 also includes an optically transmissive layer 106 configured to be removably attached to display 102 and cover at least a portion of display surface 104. Optically transmissive layer 106 includes a static image 108 printed thereon. In one example, and as described more below, the static image 108 is printed in high resolution greyscale, e.g., up to or exceeding 2400 dpi, and the greyscale image is illuminated and colorized by display 102 displaying video content, for example, static and/or dynamic image content, including static and/or dynamic shapes and static and/or dynamic colors.

Display 102 can have any of a variety of constructions known in the art for displays capable of displaying video content, such as an LED, LCD, or plasma display. As indicated in the detail view in FIG. 1, display 102 includes a plurality of pixels 110 for emitting multi-color high-resolution images, and in one example, may have a pixel spacing in the range of approximately 0.5 mm to 2 mm, and in another example, may have a pixel spacing in the range of approximately 2 mm-20 mm and in another example, may have a pixel spacing less than approximately 0.5 mm. Some example display designs that may be used for display 102 include the displays disclosed in issued U.S. Pat. No. 9,477,438 to Hochman et. al., titled “Devices For Creating Mosaicked Display Systems, and Display Mosaic Systems Comprising Same,” issued on Oct. 25, 2016. In some examples, display 102 may be one of a plurality of displays arranged in close proximity to form a large-format display (not illustrated). In such cases, an optically transmissive layer attached to the displays may be larger than the individual displays to thereby cover all or a portion of the large-format display.

The makeup of display 102 can, therefore, vary depending on the specific type of display used. By way of example only, in the case of a backlit LCD, example components located within housing 103 may include, inter alia, a backlight, diffuser, polarizer, and LCD panel. In the case of a plasma display, components inside housing 103 may include a rear plate glass, plasma panel, and front plate glass. And in the case of a solid state light source display, solid state light sources such as light emitting diodes (LEDs), organic light emitting diodes (OLEDs), polymer LEDs (PLEDs), or organic light emitting compounds (OLECs).

Optically transmissive layer 106 may have a variety of different constructions. In one example, optically transmissive layer 106 may be a film that may be made of materials including, but not limited to, polyvinyl chloride, polyolefin materials (e.g., polyethylene or polypropylene), polyester, polyethylene terephthalate (PET), polybutylene terephthalate (PBT), polyethylene naphthalate (PEN), polycarbonate (PC), polyimide (PI), polysulfone (PSO), polyphenylene ether sulfone (PES), polyethylene (PE), polypropylene (PP), polyvinyl chloride (PVC), polystyrene (PS) and polymethyl methacrylate (PMMA), polyamide (PA), polyurethane (PUR), melamine, acrylic, rubbers, and glass. Optically transmissive layer 106 may be a uniform sheet configured to be removably attached to display 102, or a woven fabric sheet configured to be stretched to the size of the display and removably attached. Examples of commercially available materials that may be used for optically transmissive layer 106 include Kodak's Universal Backlit Film, DURATRANS film, LUMIFABRIC™ from Evo Lite (http://www.evo-lite.com/), and LYTESTRETCH™ from Blue River Digital (http://www.blueriverdigital.com/). Any of a variety of attachment techniques known in the art may be used to removably position optically transmissive layer 106 proximate to display 102, including via an adhesive layer, a mechanical clamping or closure mechanism, incorporation of a bead along the perimeter of the layer configured to be disposed in a correspondingly-shaped channel in display 102, etc. In some implementations optically transmissive layer 106 may be attached directly to display 102, or in other implementations the optically transmissive layer may be spaced from the display. At least a portion of optically transmissive layer 106 may be imageable by any one or more of a variety of suitable imaging processes including, but not limited to, electrostatic printing, ink jet printing, screen printing, dye sublimation, etc., which can result in a very high resolution image, such as an image printed at 2400 dpi.

In the illustrated example, substantially all of optically transmissive layer 106 is translucent and is designed to transmit light emitted by display 102. In other examples, only a portion of the optically transmissive layer is translucent. For example, only the portion of optically transmissive layer 106 where static image 108 is located may be translucent and other portions of the optically transmissive layer may be opaque, such as my application of an opaque ink or other material.

In the illustrated example, backlit display 100 does not include a diffusion layer located between display 102 and optically transmissive layer 106. In some examples, the optically transmissive layer 106 may be in direct contact with display surface 104, and in some cases, there may be minimal spacing therebetween, such as, for example, a spacing that is approximately the same as the pixel pitch of the display. In some examples, there may be a minimum spacing between display 102 and optically transmissive layer 106, e.g., approximately the same or less than a pixel pitch of the display, but no separate light guide or diffusion component located between the display and optically transmissive layer such as a light guide plate or diffusion sheet. In other examples, such light guide or diffusion components may be added. In one example, display surface 104 may be a high-resolution pixelated surface such that minimal diffusion is required to uniformly colorize static image 108 and the diffusion that occurs in optically transmissive layer 106 is sufficient for uniform coloring. In some examples, a spacing between optically transmissive layer 106 and display surface 104 may be determined based on one or more of a transmissivity and optical diffusion characteristic of the optically transmissive layer, and a pixel pitch of the display surface. In one example, the spacing is minimized when the transmissivity of the optically transmissive layer is increased. For example, optically transmissive layer 106 and display surface 104 may be substantially in direct contact when a transparent optically transmissive layer 106 is used.

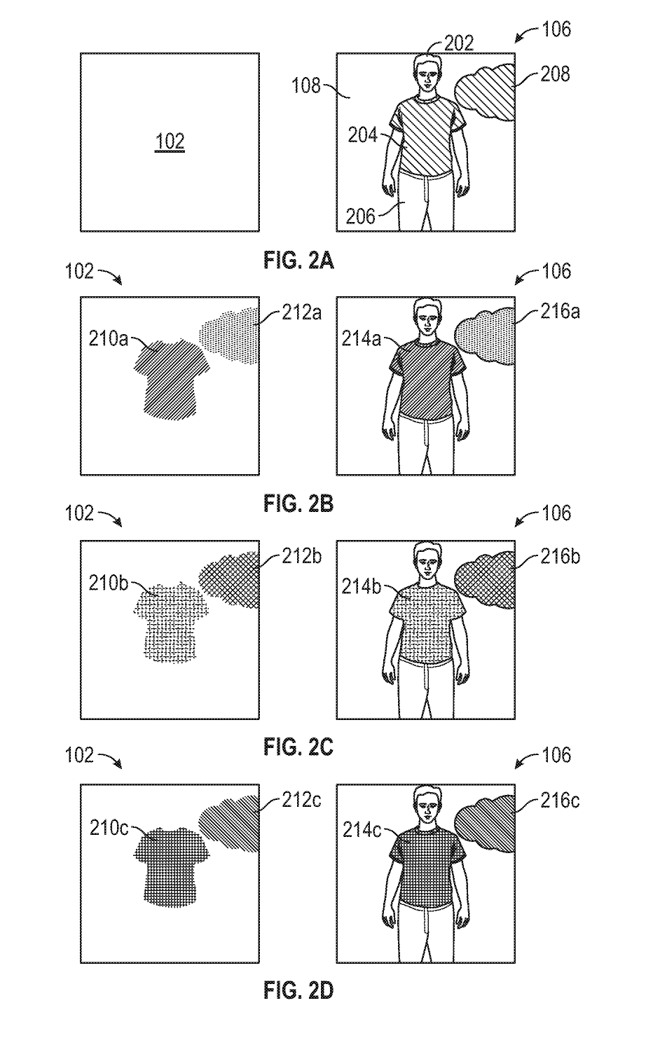

FIGS. 2A-D illustrate one example of display 102 displaying video to illuminate and colorize image 108. FIGS. 2A-D use cross hatching for various purposes. In FIG. 2A, cross hatching is used to indicate the portions of static image 108 printed in grayscale. In FIGS. 2B-D, cross hatching is used to indicate color such that each cross hatch pattern in FIGS. 2B-2D represents a different color. Each of FIGS. 2A-D show display 102 and optically transmissive layer 106 side-by-side in order to illustrate examples of video displayed by the display and the corresponding effect on the optically transmissive layer, but it should be appreciated that this is for illustrative purposes and that in use the optically transmissive layer would be positioned in front of and in alignment with the display. FIG. 2A shows display 102 when it is not displaying video and optically transmissive layer 106 in an unilluminated state. In the illustrated example, static image 108 includes an image of a person in the foreground that includes the person's body 202, t-shirt 204 and pants 206, and a cloud 208 in the background. Image 108, therefore, includes multiple regions corresponding to the components of the image, e.g, the person's body 202 (head, arms) may be one region, t-shirt 204 a second region, pants 206 a third region, and cloud 208 a fourth region. This is a simplified example of a static image for illustration purposes. In use, any level of image resolution and complexity available with modern image processing and printing can be used.

In the illustrated example, image 108 also includes image details which include lines defining the outer boundary of the image, such as the outer boundary of t-shirt 204 and cloud 208. As will be appreciated, the extent of image details can vary greatly and can be quite extensive and complex. For example, in the case of a drawing, image details may include lines indicating shading, surface contour, and additional features of the image, such as, for example, in the case of t-shirt 204, logos, stitching, buttons, etc. In the case of a photograph, image details can include any additional details conveyed in a photograph of, for example, surface folds, contours, etc. that are visible in a photograph of a t-shirt being worn by a person. In the illustrated example, at least t-shirt 204 and cloud 208 are printed in greyscale, which is indicated in FIG. 2A by a cross hatch pattern. Greyscale, as used herein, broadly refers to an image having the general appearance of being black and white and can be formed via any process known in the art, including color desaturation, by a greyscale conversion, or by creating in greyscale in the first instance. In the illustrated example, the remainder of transmissive layer 106 is not printed in greyscale. In one example, the remainder of image 108 is printed in color. In other examples, more or less of image 108 up to and including all of the image, can be printed in greyscale.

Referring to FIG. 2B, display 102 is shown displaying a video that includes a first shape 210a that corresponds to an outline or outer shape of t-shirt 204 and a second shape 212a that corresponds to an outline or outer shape of cloud 208. First and second shapes 210a, 212a have first and second colors for colorizing t-shirt 204 and cloud 208, respectively and the first and second shapes are scaled and positioned on display 102 such that they are in alignment with the t-shirt and cloud when optically transmissive layer 106 is positioned in front of the display. Two different cross hatch patterns are used in FIG. 2A to indicate the two different colors of first and second shapes 201a, 212a. In the illustrated example, first and second shapes 210a, 212a do not include the image details associated with image 108 described above, such as surface details and features. Instead, first and second shapes 210a, 212a are merely regions of color. In other examples, first and second shapes 210a, 212a may include some or all of the same image details included in image 108. In the illustrated example, each of first and second shapes 210a, 212a have a homogeneous color. In other examples, each shape 210a, 212a may include a plurality of colors.

FIG. 2B also shows optically transmissive layer 106 when illuminated by display 102 shown in FIG. 2B with shapes 210a and 212a. As shown, shapes 210a and 212a colorize t-shirt 204 and cloud 208, creating a colorized t-shirt 214a and colorized cloud 216a, with the cross-hatching in t-shirt 214a and colorized cloud 216a indicating the coloring. In the illustrated example, because the video displayed by display 102 only includes shapes 210a, 212a, other portions of image 108, such as the person's body 202 and pants 206 are not colorized by display 102. In one example, the video displayed by display 102 may include white light or some other color light in portions of the display other than where shapes 210a and 210b are located for illuminating the remainder of optically transmissive layer 106.

In FIGS. 2C and 2D, display 102 is displaying shapes 210b, 212b (FIG. 2C) and 210c, 212c (FIG. 2D) where each have different colors, as indicated by the different cross-hatching patterns, resulting in colorized t-shirt and cloud 214b, c and 216b, c, respectively. In the illustrated example shapes 210a-c and 212a-c have substantially the same shape and differing colors. Thus, as shown in FIGS. 2B-2D, display 102 can be configured to display video with time-varying colors to thereby dynamically colorize image 108 with time-varying color. In other examples, the size or shape of shapes 210, 212 may vary, and additional or fewer shapes may be added or removed, according to a video signal provided to display 102. In general, display 102 can be configured to illuminate any combination of portions of optically transmissive layer 106 with any combination of static or time varying shapes with static or time varying colors. Display 102 may also be configured to display video with time varying color that creates the impression or illusion of movement in image 108. For example, in the case of an image of a fish or tree, the illusion of the fish swimming in water or the branches of the tree swaying in the wind.

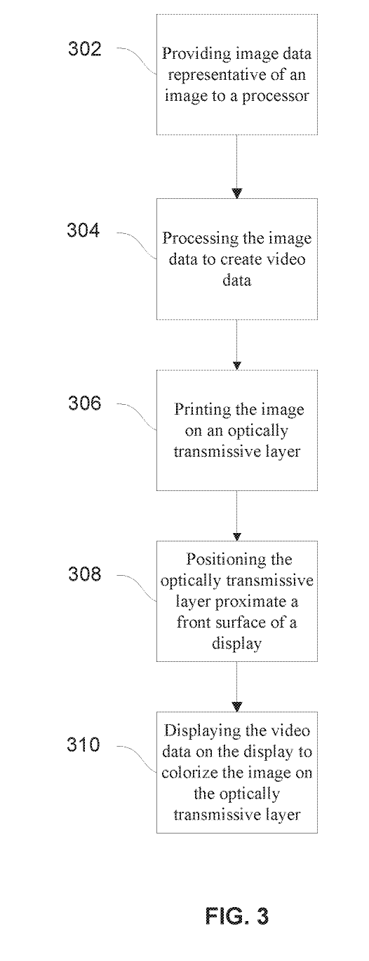

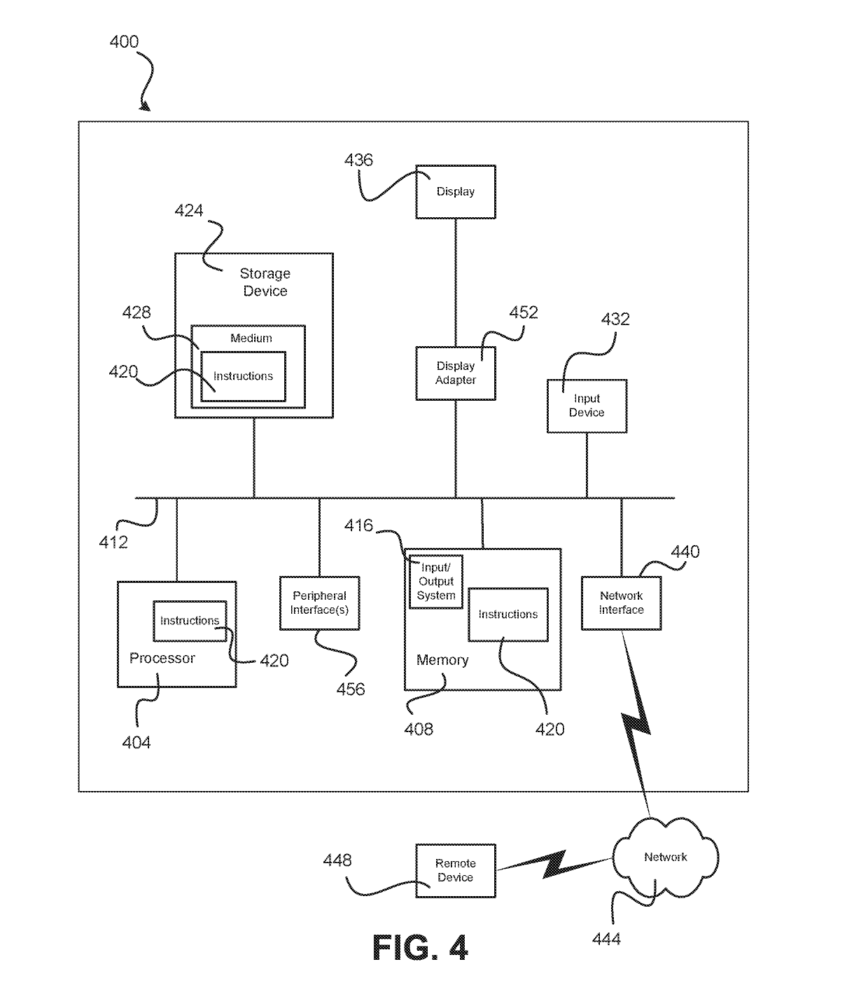

FIG. 3 shows one example of a method 300 of displaying, which may be performed with display 100 and system 400 (FIG. 4). As shown, at step 302, the method may include providing image data representative of an image, such as image 108, to a processor, such as processor 404 (FIG. 4). At step 304, the image data may be processed to create video data for display. In one example, a processor with photo and video authoring software, such as an Adobe Photoshop® software application, may be used. In one example, video data may be created by creating one or more mask layers based on a shape of all or a portion of the image. The mask layer can be defined to ensure the video content will be displayed on the correct pixels of display 102 that are in alignment with image 108 when optically transmissive layer 106 is attached to the display. In some examples, a static image signal representative of the static image is processed for determining a first group of pixels aligned with the static image. In some examples, the information can be provided in a video data format to a display to illuminate only a first group of the pixels aligned with the static image according to the video data that includes information defining a shape to be positioned in alignment with the image when the optically transmissive layer is attached to the display. In one example, a mask layer is defined for the one or more shapes, e.g., shapes 210, 212 (FIG. 2) so that they are in a location on the screen in alignment with a location of image 108, and defined at substantially the same aspect ratio as display 102 and the optically transmissive layer to set the scale of the shapes. A color profile may then be defined for various regions of the mask. Example color profiles include static or time varying colors with either one color or a plurality of colors being displayed at any one time. Areas outside of the shapes defined by the mask may be set to black if no other illumination is desired, white, if illumination of other areas is desired, or some other color.

At step 306, the image data that was used to create the video data can also be used to print an image according to the image data on an optically transmissive layer, such as optically transmissive layer 106. At step 308, the optically transmissive layer with image printed thereon can be removably coupled to or otherwise positioned in front of a display, and at step 310, the video data created in step 304 may be provided to the display, causing the display to display video, thereby colorizing and illuminating the optically transmissive layer.

Any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 4 shows a diagrammatic representation of one embodiment of a computing device in the exemplary form of a computer system 400 within which a set of instructions for causing a display system, such as display 100 of FIG. 1, to perform any one or more of the aspects and/or methodologies of the present disclosure. It is also contemplated that multiple computing devices may be utilized to implement a specially configured set of instructions for causing one or more of the devices to perform any one or more of the aspects and/or methodologies of the present disclosure. Computer system 400 includes a processor 404 and a memory 408 that communicate with each other, and with other components, via a bus 412. Bus 412 may include any of several types of bus structures including, but not limited to, a memory bus, a memory controller, a peripheral bus, a local bus, and any combinations thereof, using any of a variety of bus architectures.

Memory 408 may include various components (e.g., machine-readable media) including, but not limited to, a random access memory component, a read only component, and any combinations thereof. In one example, a basic input/output system 416 (BIOS), including basic routines that help to transfer information between elements within computer system 400, such as during start-up, may be stored in memory 408. Memory 408 may also include (e.g., stored on one or more machine-readable media) instructions (e.g., software) 420 embodying any one or more of the aspects and/or methodologies of the present disclosure. In another example, memory 408 may further include any number of program modules including, but not limited to, an operating system, one or more application programs, other program modules, program data, and any combinations thereof.

Computer system 400 may also include a storage device 424. Examples of a storage device (e.g., storage device 424) include, but are not limited to, a hard disk drive, a magnetic disk drive, an optical disc drive in combination with an optical medium, a solid-state memory device, and any combinations thereof. Storage device 424 may be connected to bus 412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 424 (or one or more components thereof) may be removably interfaced with computer system 400 (e.g., via an external port connector (not shown)). Particularly, storage device 424 and an associated machine-readable medium 428 may provide nonvolatile and/or volatile storage of machine-readable instructions, data structures, program modules, and/or other data for computer system 400. In one example, software 420 may reside, completely or partially, within machine-readable medium 428. In another example, software 420 may reside, completely or partially, within processor 404.

Computer system 400 may also include an input device 432. In one example, a user of computer system 400 may enter commands and/or other information into computer system 400 via input device 432. Examples of an input device 432 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 432 may be interfaced to bus 412 via any of a variety of interfaces (not shown) including, but not limited to, a serial interface, a parallel interface, a game port, a USB interface, a FIREWIRE interface, a direct interface to bus 412, and any combinations thereof. Input device 432 may include a touch screen interface that may be a part of or separate from display 436, discussed further below. Input device 432 may be utilized as a user selection device for selecting one or more graphical representations in a graphical interface as described above.

A user may also input commands and/or other information to computer system 400 via storage device 424 (e.g., a removable disk drive, a flash drive, etc.) and/or network interface device 440. A network interface device, such as network interface device 440, may be utilized for connecting computer system 400 to one or more of a variety of networks, such as network 444, and one or more remote devices 448 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 444, may employ a wired and/or a wireless mode of communication. In general, any network topology may be used. Information (e.g., data, software 420, etc.) may be communicated to and/or from computer system 400 via network interface device 440.

Computer system 400 may further include a video display adapter 452 for communicating a displayable image to a display device, such as display device 436. Examples of a display device include, but are not limited to, a liquid crystal display (LCD), a cathode ray tube (CRT), a plasma display, a light emitting diode (LED) display, and any combinations thereof. Display adapter 452 and display device 436 may be utilized in combination with processor 404 to provide graphical representations of aspects of the present disclosure. In addition to a display device, computer system 400 may include one or more other peripheral output devices including, but not limited to, an audio speaker, a printer, and any combinations thereof. Such peripheral output devices may be connected to bus 412 via a peripheral interface 456. Examples of a peripheral interface include, but are not limited to, a serial port, a USB connection, a FIREWIRE connection, a parallel connection, and any combinations thereof.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A backlit graphical display, comprising:
a display having a display surface, the display including a plurality of pixels for displaying images based on video data received by the display; and
an optically transmissive layer having a static image printed thereon, the optically transmissive layer positioned in front of the display surface, wherein the display colorizes the static image according to the video data.

2. A backlit graphical display according to claim 1, wherein the optically transmissive layer is translucent.

3. A backlit graphical display according to claim 2, wherein the static image extends across a substantial portion of the display surface.

4. A backlit graphical display according to claim 1, wherein the optically transmissive layer is a polymeric film or fabric.

5. A backlit graphical display according to claim 1, wherein the display includes a controller for receiving a static image signal representative of the static image for determining a first group of the pixels aligned with the static image.

6. A backlit graphical display according to claim 1, wherein the display is configured to illuminate only a first group of the pixels aligned with the static image according to the video data.

7. A backlit graphical display according to claim 1, wherein the static image includes first and second portions, the display configured to illuminate a first group of the pixels aligned with the first portion according to a first part of the video data and illuminate a second group of the pixels aligned with the second portion according to a second part of the video data.

8. A backlit graphical display according to claim 1, wherein there is no diffusion layer between the display surface and the optically transmissive layer.

9. A backlit graphical display according to claim 1, wherein the static image is a greyscale image, the display configured to colorize the greyscale image.

10. A method of providing a backlit display, comprising:
providing a display having a display surface;
positioning an optically transmissive layer in front of the display surface, the optically transmissive layer having an image printed thereon; and
colorizing the image with the display according to video data received by the display.

11. A method according to claim 10, wherein at least a portion of the image is opaque.

12. A method according to claim 10, wherein the video data includes information defining a shape to be positioned in alignment with the image when the optically transmissive layer is attached to the display.

13. A method according to claim 12, wherein the shape includes a first region for colorizing a corresponding first region of the image with a first color and a second region for colorizing a corresponding second region of the image with a second color that is different than the first color.

14. A method according to claim 13, wherein the first region of the image includes image details that are not displayed in the shape.

15. A method according to claim 12, wherein the shape corresponds to an outline of the image.

16. A method according to claim 10, wherein the video data includes time-varying color information.

17. A method according to claim 16, wherein the time-varying color information is designed to create an appearance of movement in the image.

18. A method according to claim 10, further comprising diffusing light emitted by the display with the optically transmissive layer.

19. A method according to claim 18, wherein substantially all diffusion of light emitted by the display occurs in the optically transmissive layer.

20. A method according to claim 10, further comprising:
providing image data representative of the image to a processor; and
processing, with the processor, the image data to create the video data.

21. A method according to claim 20, wherein the processing includes creating a mask layer of the image.

22. A method according to claim 21, further comprising adding color information to the mask layer.

23. A method according to claim 22, wherein the color information includes at least one of defining a plurality of color regions in the mask layer and time varying color information.

24. A method according to claim 20, wherein the shape corresponds to an outline of the image, wherein the processing further includes defining a plurality of regions within the shape and assigning color profiles to each region.

25. A method, comprising:
providing an optically transmissive layer having a translucent static image printed thereon; and
creating video data according to the static image for use in colorizing the static image with an electronic display.
